(19) United States
(12) Patent Application Publication
(10) Pub. No.: US 2014/0114737 A1
(43) Pub. Date: Apr. 24, 2014

(54) BUSINESS TO NETWORK REWARD SYSTEM

(71) Applicant: Raul Augusto Triveno Espejo, Lima (PE)

(72) Inventor: Raul Augusto Triveno Espejo, Lima (PE)

(21) Appl. No.: 13/655,124

(22) Filed: Oct. 18, 2012

(51) Int. Cl. G06Q 30/02

(52) U.S. Cl. 705/14.27

(57) ABSTRACT

A business to network reward system. The system allows users to earn rewards, which are shared with others in their social networks. Rewards may be earned through transactions with businesses associated with the system. As rewards are earned, reward information is distributed through the social network to users who share the reward. This distribution of reward information occurs in a positive context for creating a favorable impression of the business. The positive context is created by a user receiving a reward, for which the recipient took no express action. The context is also positive because of an implied endorsement of the business that comes from a network connection of the recipient having transacted business with that business. As a result, a business may be incented to offer a greater reward, which entices more users to the system, and in turn offers greater value to the business.

### BACKGROUND

Social networks allow people and businesses to take advantage of communications capability provided by networked computer systems to connect with other people or businesses. Social network systems, such as FACEBOOK and LINKED IN, allow their users to make connections to other users by sending requests. When one user accepts a request from another user, each user becomes a member of the other user's network and those users are said to be connected. In some social network systems, connected users may be described as “friends” or “connections.”

Users of the social network system have a profile page, for which they can control the content. A user may control access privileges to their profile page. In general, users may allow other users to whom they are connected to access all or portions of the content on their profile pages or to send messages that will appear for a user when that user logs into the social network system. Thus, the profile pages provide a mechanism for users in the same social network to exchange information through the social network system.

In this way, users may share with their networks personal or business information. This information may include photographs or short messages. In addition, users may share links to profile pages of other users, which may be the profile pages of businesses on products, with an indication of a like or a dislike of the target of such a link. In this way, users may share their views about businesses or products.

The concept of a network may extend beyond a direct connection between two users. In some systems, and depending on access privileges, a user may allow second or higher level connections to exchange information with them. Second level connections may be connections of first level connections. Third level connections may be connections of second level connections, etc.

Though social networks are widely used for sharing of personal information, they have also been used to some extent for marketing commercial entities. For example, some businesses encourage social network users to include links to their profile pages and to post information, sometimes call a “like,” indicating a favorable impression of the business. Such encouragement may be presented in the form of an advertisement that encourages viewers to “Like us on FACEBOOK.” Information, when distributed through a social network, may be valuable to a business because it might reach numerous potential customers.

Though, other techniques to reach potential customers exist. Traditional media, such as newspaper, television and radio advertising, is still used. In addition, web-based advertisements are known. Further, rewards programs are known. In a rewards program, a user is provided some reward for buying a product or service. The reward might be provided by the business from which the product or service is purchased. The consumer might also supply a reward via a “keep the change” feature. These rewards might be in the form of “points” or actual monetary amounts that can be collected in an account operated for a user. The user might from time-to-time access their account to access the accumulated value of the rewards in the account. Such access may entail withdrawing a cash amount or exchanging the points for products or other things of value to the user.

### SUMMARY

The inventor has recognized and appreciated significant benefit that arises from sharing a reward, accumulated through a rewards program, between a user who took an action to earn the reward and members of that user's social network.

Accordingly, in some aspects, the invention relates to a method of operating at least one computing device to provide rewards to users of a social network. The social network may be implemented by the users' interactions with a computing system. The method may include receiving information about an incented action by a first user of the social network. The method may also include distributing a reward for taking the incented action to the first user of the social network and at least one other user of the social network. The at least one other user of the social network may be connected to the first user within the social network.

Some embodiments relate to at least one computing device for use in administering a business to network reward system in connection with a social network. The at least one computing device may include at least one network interface, at least one memory device and at least one processor. The at least one network interface may be adapted to receive requests from a plurality of users of the social network and a plurality of businesses affiliated with the social network. The at least one memory device may be adapted to store user information, business information and transaction information, the transaction information being related to transactions between users and businesses. The at least one processor may be adapted to manage the user information, the business information and the transaction information. The processor may receive, from the network interface, information about a transaction by a first user of the social network, the transaction involving a business affiliated with the social network. The processor may also update first user information of a first user stored in the at least one memory device, by allocating a portion of a reward to the first user, the reward being based on the transaction. The processor may also update second user information stored in the at least one memory, the second user information relating to at least a second user of the social network, and the second user information being updated by allocating a portion of the reward to the at least one second user. Each of the at least one second users may be connected to the first user via the social network.

Some embodiments relate to at least one non-transitory computer-readable storage medium comprising computer-executable instructions that, when executed, perform a method of providing rewards to users of a social network. The method may include receiving information about at least one transaction related to a business, the transaction being performed, by a first user of the social network. The method may also allocate a reward for performing the transaction to the first user of the social network and at least one other user of the social network, wherein the at least one other user of the social network is connected to the first user.

The foregoing is a non-limiting summary of the invention, which is defined by the appended claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1A is a simplified block diagram of a conventional business-to-consumer environment;

FIG. 1B is a simplified block diagram of a business-to-network environment according to some embodiments of the present invention;

FIG. 2 is a simplified block diagram of the operation of a business-to-network rewards system according to some embodiments of the present invention;

FIG. 3 is a schematic flow diagram of a purchasing process according to some embodiments of the present invention;

FIG. 4 is a screenshot of a user interface with a user wish list presented by a business-to-network rewards system according to some embodiments of the present invention;

FIG. 5 is a screenshot of a user interface with a product page for a product within a wish list presented by a business-to-network rewards system according to some embodiments of the present invention;

FIG. 6 is a schematic flow diagram of a wish list creation process according to some embodiments of the present invention;

FIG. 7 is a schematic flow diagram of a business-to-network system process according to some embodiments of the present invention;

FIG. 8 is a screenshot of a sellers' marketplace page in a business-to-network rewards system according to some embodiments of the present invention;

FIG. 9 is a screenshot of a user's profile page in a business-to-network rewards system according to some embodiments of the present invention; and

FIG. 10 is a simplified block diagram of an exemplary network environment in which at least a portion of the business-to-network system may implemented according to some embodiments of the present invention.

### DETAILED DESCRIPTION OF SOME ILLUSTRATIVE EMBODIMENTS

The inventor has recognized and appreciated that sharing a reward, accumulated through a rewards program, between a user who took an action to earn the reward and members of that user's social network may provide multiple benefits. Both consumers and business may see benefits.

A system implementing such a “business-to-network” reward program may provide benefits to the users. Each user has the opportunity to earn rewards from their own purchases and other actions for which businesses are willing to offer incentives. Additionally, opportunities for earning rewards are magnified because the user can earn rewards based on the actions of other users in their social network.

Such a “business-to-network” reward program also may provide benefits to businesses offering rewards. As information about rewards is shared among members of a social network, information about the business may be inherently shared. Such information may highlight a product or service of the business. Thus, by participating in the system that shares a reward with a social network rather than a single user, a business achieves a degree of advertising that is not available in a conventional reward system.

By providing rewards to the consumer's friends and colleagues, and not just the consumer, the rewards reach more people and aid in the marketing of the business. This marketing to a network is more targeted than traditional marketing because consumers, who are connected to consumer via the social network, are likely to have similar interests such that if one person in the network is interested enough to buy a product or service from the business, other members of the network are more likely to be interested to, than people who might randomly receive an advertisement.

Further, the distribution of rewards to an entire network of consumers provides incentives for each of the social network members to share business and product information with the network and become connected with as many people with like interests as possible. By being well connected and sharing as much information about a business's products and/or services as possible, each member of that network receives financial rewards even if just a single member of the network makes a purchase from the business. This distribution of rewards may be completely passive. A user may receive rewards without clicking links, posting comments, or any other type of interaction. Rather, friends will receive a share of the reward just by being friends with, or any suitable degree of separation from, a consumer making a purchase at a participating business or otherwise taking an incented action.

Moreover, information about the business is shared in a positive context, creating added benefit to the business. For example, the system may report to a user that a reward, earned by another member of their network, has been shared with them because of a purchase at a particular business. Thus, that user might learn or be reminded of that business in the desirable context of receiving a reward for which that user took no express action, which is more likely to generate a favorable association with the business than other forms of advertising.

As yet another example of this positive context, the user will learn of or be reminded about the business based on actions of another person in their social network. Such actions serve as an implied endorsement for the business. Because social networks are voluntarily formed groups of people, there is often a degree of affinity among the members of a network that would cause a user receiving an implied endorsement from another member of their social network to attach significant credence to that endorsement.

Thus, the positive context in which a business gets to share information with prospective customers in this business to network model can be of significant value to the business. As a result of the added value to a business, the business may be willing or able to afford to offer higher rewards than offered through conventional reward programs. In this way, benefits to the businesses may translate into even greater benefits to the users.

Such a business to network reward system may be implemented in any suitable way. For example, it may be a stand-alone social networking system. Alternatively or additionally, the system may be implemented using apps, gadgets, widgets, plug-ins or other components that interface to an existing social network system. Access to the system may be made through any suitable device include a point of sale (POS) system or mobile apps. Access may be made based on any suitable information, including information about users, purchasers, businesses, products or transactions. This information may be collected in any suitable way, including through codes in physical product packaging. These components, for example, may use the existing account structure of such a social networking system to track information about users, such that existing infrastructure is used to track information about earned rewards and redemptions. In these embodiments, the business to network reward system also may use existing infrastructure of the social networking system to identify members of networks for distributing rewards and reward information. Such functionality may be implemented by one or more apps coded to execute on a platform provided by that social networking system.

Alternatively or additionally, the system may be integrated in an existing reward system. In these embodiments, the business to network reward system may use existing infrastructure of the reward system to track rewards and redemptions. That infrastructure may include a traditional point of sale system, for example. In yet other embodiments, a business to network reward system may be implemented by integrating an existing social networking system and an existing reward system. In these embodiments, the business to network reward system might be implemented as components that interact with and fuse information from the two systems. Accordingly, it should be appreciated that one of skill in the art could implement a business to network reward system as described herein in any of a number of ways, such that the specifics of implementation are not a limitation on the invention.

Though such a business to network reward system may be implemented using known technology, it may contain novel features to support distribution of rewards to a network. For example, the system may include one or more components to determine allocation of rewards earned by one user to other users in a social network with that user. Such components, for example, may compute an allocation using one or more criteria. Those criteria may be proprietary to the business to network reward system, publicized, supplied by a user, supplied by a business offering a reward and/or provided by any other party. Such a system may support one or more user interfaces to allow such criteria to be entered and/or support other functions, such as the dissemination of reward information.

Further, the business to network reward system may be implemented such that rewards may be earned and shared in real time. As a result, rewards may be earned, and are ready to be spent, in real time. For example, if a user makes a qualifying transaction, a cash back reward will be earned by a friend, and reflected in information about that friend's account with the business to network reward system with such a short delay that they will seem instantly available for the friend to spend. In some embodiments, the rewards may be made available even though the operator of the business to network reward system has yet to collect the actual payment.

In some embodiments, the business to network reward system may include one of levels of identity (ID) verification. In some embodiments, any user may accumulate rewards. however, to use an accumulated reward, an ID verification process may be performed by the system. In this context, ID verification may reduce the risk of virtual ID theft because users will be thwarted from using rewards earned by impersonating a “popular” public figure. ID verification also may have the added benefit of allowing the system to easily recognize fake social accounts because they are not verified. Accordingly, ID verification may be used in conjunction with a business model that allows accumulated rewards to be accessed by users before payment for those rewards are received by the system from businesses.

Regardless of how implemented, businesses of any suitable type may be associated with the business to network reward system. Such businesses may fill one or more roles with respect to the system. For example, some businesses may define the incented actions that enable users to earn rewards. The incented actions, for example, may include: making a purchase of a specified good, service or other product; making a purchase at, visiting or taking some other action with respect to a specified retail location; or using a specified credit card or other payment mechanism. Though, it should be appreciated that a system as described herein may support incented actions in any suitable form or forms. In some embodiments, such incented actions may not require a direct commercial action by the user that earns the reward. For example, an incented action may entail referring a “friend” by providing information about a business or product to a friend or vice versa.

In some embodiments, the business defining the incented action may supply the reward when the incented action is performed. The reward may be provided in any suitable way. For example, a business associated with the system may determine that an incented action occurred and report that activity to the entity managing the business to network reward system. Either in conjunction with the report, or at any other suitable time or interval, the business may provide a payment to the entity managing the business to network reward system. Such an approach may be used when the reward is a monetary reward or can be reduced to a monetary value. For example, a reward given in the form of points may be given a monetary value based on an average monetary cost associated with redeeming points.

Alternatively or additionally, the business supplying the reward may supply the reward at the time of reward fulfillment. For example, when a user earns a reward in the form of a free or discounted product, service or other thing of value, the business to network reward system may issue to the user a coupon, code or other form of voucher that will be honored by a business. The business may provide the user with the reward in exchange for such a voucher. In some embodiments, the business may honor the voucher as part of its association with the business to network reward system without any specific additional consideration for the redemption. In other embodiments, agreements between a business fulfilling a reward and the entity managing the business to network reward system may result in a transaction, such as a payment or a credit, that compensates the business for fulfilling the reward.

Alternatively or additionally, the business supplying the reward may do so as part of a financial transaction with the entity managing the business to network reward system that need not be associated with a specific reward transaction. For example, businesses associated with the business to network reward system may make a subscription payment covering a period of time. Such payments may be in any suitable form. For example, such a payment may be monetary or may be in the form of free or discounted product, service or other thing of value. Regardless, of the form of the subscription payment, it may be used by the business to network reward system to fund rewards issued.

In some embodiments, businesses are able to invite customers to join a social network and offer them social rewards on all of their purchases. Though such an approach may seem counter-productive as it would create higher costs for the seller, because rewards are being offered to current customers rather than for referrals. However, in the business to network reward system, such an approach allows a new kind of marketing, in which a seller's current costumers potentially become a powerful sales and marketing network. They are already customers, and as such, can recommend the seller and the rewards system to their friends, this time with the incentive of earning a percentage of a reward on each of their friends' purchases. The multiplying effect this will have on customers and the increased sales and market share will offset the initial cost to the business of rewarding existing customers, such as by providing them with cash back.

Other roles that may be filled by businesses associated with the business to network reward system include providing information about offered rewards and incented actions. Such information, for example, may be in a form that allows users of a social network to forward the information to other users in their social networks to encourage others in the network to take the incented action.

Such a business to network reward system may also be augmented with other features that provide further value to users and/or businesses. These features may be of the type that is known to exist in a conventional social networking system or a conventional reward system. Alternatively or additionally, these features may augment the benefits to users or businesses interested in a business to network reward program.

For example, in some embodiments, the system may provide one or more features that allow users to receive information about products, services or other things of value associated with offered rewards. These features may allow users, businesses or the entity managing the business to network reward system to initiate the dissemination of information. For example, the system may support profile pages or other interfaces that allows users to share information with other users connected in a social network. The posted information may relate to products or services that may entitle users to earn rewards or otherwise may relate to rewards.

Through such an interface, for example, a user may post a wish list of items the user would like to have. Such a posting may create social expectations that others will purchase items on the wish list for the user. In conjunction with such a posting, that user, or other users with access to the posting may see comments by other members of the social network about items on the wish list. Alternatively or additionally, such a posting may convey reward information. As yet another possibility, such a posting may enable users sharing a common interest in the product to communicate, such as by using electronic messages in the form of a chat or bulletin board through which interested users may post information visible to other users that similarly posted the product on their wish lists or otherwise expressed interest in the product.

As another example of features that may be supported, the business to network reward system may support interfaces that facilitate users buying products or services for which rewards are offered. The system may support links to web sites of businesses offering products that, when purchased, would earn rewards for the user and the user's network. Alternatively or additionally, the features may include an on-line store through which a user may directly purchase products or services that earn rewards.

As yet another example of a feature that may be supported, the system may support a dynamic reward function. With such a feature, a business may be provided with an interface to the system, or other suitable mechanism, through which the business may specify rewards based on one or more criteria that may be dynamically applied by the system to determine either whether an award is earned or the amount of the award. For example, a business may be able to specify a percentage of a purchase amount earned as an award that is computed in accordance with a formula based on one or more criteria. Those criteria could include, for example, time and location of the purchase.

As an example of how such a dynamic reward could be applied, as a result of allowing reward amounts to be specified based on a time criteria, cash back sales can be established where a higher percentage will be rewarded in a specific timeframe. As a result of allowing reward amounts to be specified based on a space criteria, depending on a user's location, which can be ascertained via mobile devices, for example, higher rewards can be activated and offered. These criteria might also be used together to provide an event-driven reward customization. For example, all users at a concert, which occurs in a pre-defined time and location, can be rewarded at a higher percentage due to their participation in such an event. This feature can be combined with push notifications in order to provide one click purchases tailored towards the event, with higher rewards. For example, users present at the Superbowl, can be push-notified (such as through an electronic message) of a large reward, such as 30% cashback, on team merchandise.

As yet another feature, the system may support any user, whether or not a traditional business, creating a personal online store. In this way, a user can act as a business, by offering products and services via a personal store. When someone makes a purchase through the personal store, the user hosting that personal store may choose to have offer a reward processed through the business to network reward system such that a reward is distributed to the buyer and his friends. In this way, any user of the social network can take advantage of the business to network reward system.

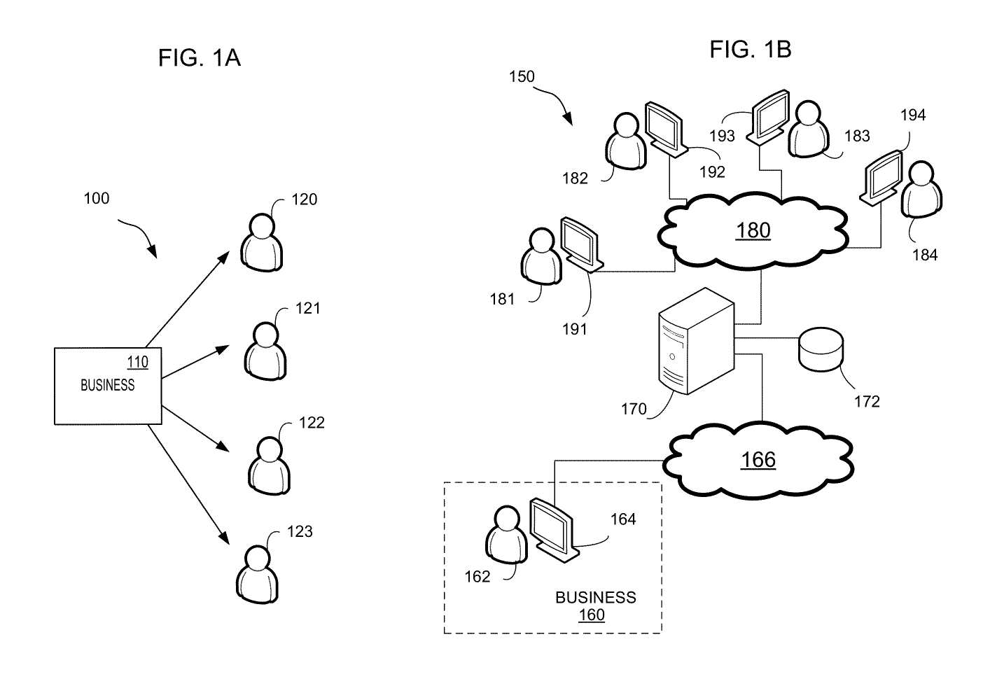

Thus, it should be appreciated that a business to network reward system as described herein may support multiple types of transactions. Transactions among users of a business to network reward system, an entity managing a business to network reward system and a businesses associated with a business to network reward system as described herein may be performed in any suitable way. In some embodiments, the transactions will be performed based on electronic communications over a computer network. In FIG. 1B, an example is provided of a computing environment in which such transaction s may occur, which may be directly compared to an environment that uses the conventional business-to-consumer (B2C) environment 100, as illustrated in FIG. 1A.

In the B2C environment of FIG. 1A, the business 110 markets directly to each of a plurality of consumers 120-123. Marketing to each individual consumer 120-123 may be costly and time-consuming and it may be difficult to target consumers that are interested in the product and/or service offered to consumer by the business 110. Moreover, in the B2C environment, once business 110 attracts consumer 120 and consumer 120 purchases the offered product and/or service, it may be difficult to get repeat business from consumer 120 and convert the consumer 120 into a loyal customer of the business 110. Business 110 may attempt to incentivize the consumer 120 to return to the business 110 for additional products and/or services by offering coupons or a loyalty card which offers occasional discounts. Additionally, there is no dependable way to get consumer 120 to tell his friends and colleagues about the product and/or service he received from business 110. Occasionally, a consumer 120 may tell another consumer 121 about business 110, but this word-of-mouth process of reaching other consumers is slow and unreliable. Moreover, there is no incentive for consumer 120 to tell other consumers about the business or the product and/or service the business provides.

FIG. 1B illustrates an exemplary embodiment of a business-to-network (B2N) system 150. In the illustrated embodiment, an owner or employee 162 of business 160 may market and provide incentives to an entire network of consumers via a social network, thereby making a social network a place where users can actually make and save money. In the embodiment illustrated, the offered reward is “cashback” and the incented action is buying a product or service from business 160. When a consumer 181 purchases a product and/or service from a business 160, the business 160 may provide a cashback reward that is shared with others in the network of consumer 181. The business 160 may communicate with a business to network reward system over a network, such as the Internet 166, using at least one computer system 164. Any suitable computer system 164 may be used. For example, the computer system may be a desktop or laptop computer. Alternatively, the computer may be a mobile phone, tablet computer, point of sale terminal, ATM or any other device with one or more applications used to interface with the business to network reward system. Embodiments are not limited to any particular type of computer system.

The social network may be implemented using at least one computer system 170. The at least one computer system 170 may be, for example, a plurality of server computers. The at least one computer system 170 may communicate with one or more databases 172. In some embodiments, the one or more databases 172 may be separate from the at least one computer system 170. Alternatively, the database may be implemented by the at least one computer system 170 itself. The computer system 170 and the database 172 store information about the social network and the computer software to implement the processes and method of the social network. For example, the information about the social network may include user accounts and accounts for affiliated businesses (such as business 160).

The user accounts may be stored on any suitable storage device, such as database 172. The user accounts may store information about the user. In some embodiments, the user information may be information used by the business to network reward system to track user activities. For example, the user information may be used to determine if the user is qualified for a reward. In other embodiments, the user information may be used by the business to network reward system to distribute a reward to the user. Some embodiments may use the user information to fulfill a purchase made by the user. For example, in some embodiments, the user information of the user account may include the name of the user; a physical address of the user; bank account information; credit card account information; the names of other users to which the user is connected; a wish list, which may include a list of products and/or services that the user would like to purchase; a list of businesses, products and services that the user likes; a date and time that the user joined the social network; a total amount of cashback that the user has received via the social network; and/or a history of the user's transactions on the social network.

The affiliated business accounts may be stored on any suitable device, such as the database 172. The accounts for the affiliated businesses may store information about the business. In some embodiments, the business information may be information that is used by the business to network reward system to obtain and/or invoice for a reward payment from the business. In other embodiments, the business information may be used to validate an incented action by a user at the business. Some embodiments may use the business information to determine the amount and/or type of reward offered by the business for particular products and/or services. For example, in some embodiments, the business information in each affiliated business account may include the name of the business; the physical address of the business; bank account information; a list of products and/or services offered for sale by the business; and/or a history of the transactions the business has been a part of via the social network.

Each user of the social network 181-184 may use at least one computer system 191-194, respectively, to access the at least one computing system 170 that implements the social network. Any suitable computer system may be used. For example, the computer systems 191-194 may each be a desktop or laptop computer. Alternatively, each of the computer systems may be a mobile phone or tablet computer with one or more applications used to interface with the social network. Embodiments are not limited to any particular type of computer system. Moreover, it is not a requirement that a user access either the social network or the business to network rewards system using a conventional computer. Interaction with these systems may be initiated via any device connected to the Internet, a mobile phone, an SMS message, or even as a response to an invite via a physical retailer.

The users' computer systems 191-194 may connect to the computer system 170 via a network 180, such as the internet. Network 180 may be the same network as network 166. Alternatively, the network 180 may be a separate network from network 166. Embodiments are not limited to any particular type of network.

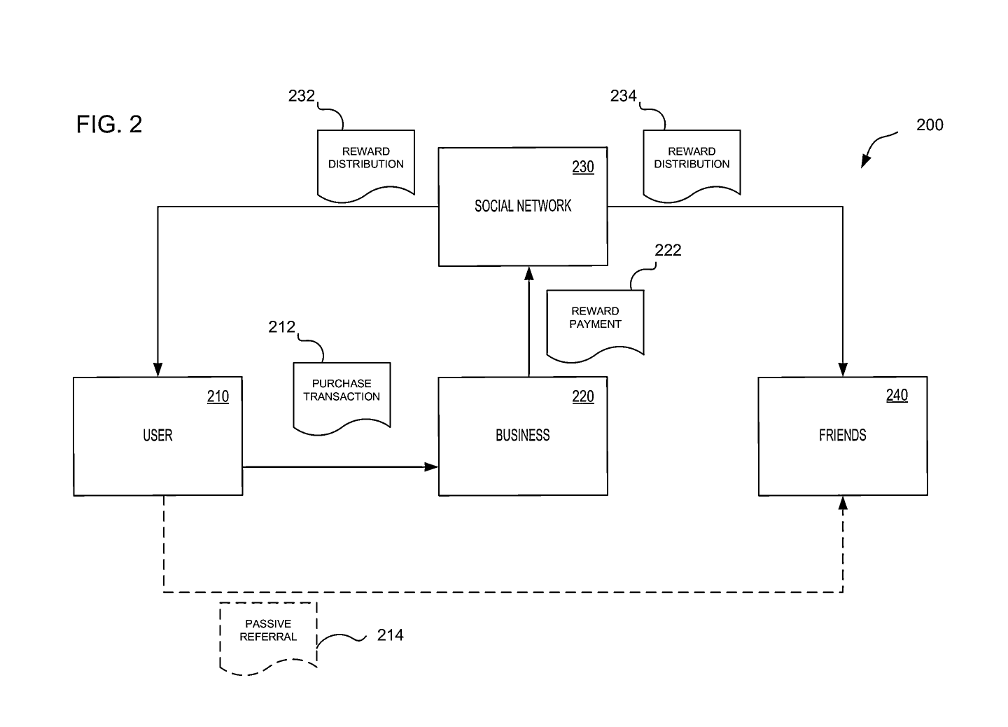

FIG. 2 illustrates a block diagram overview of how embodiments of a business to network reward system may operate. A user 210 performs at least one incented action. For example, the incented action may be purchasing at least one product and/or service from business 220. The purchase may be made in any suitable way. For example, the user may send a purchase transaction request 212 to business 220 via a web site of the business 220. Alternatively, the user may make a purchase in person at a physical store of business 220. In other embodiments, the user 210 may make a purchase from business 220 through a store implemented on the social network 230 itself.

Based on the incented action, the business 220 sends a reward payment 222 to the operator of the social network 230. The reward payment 222 may be a percentage of the purchase price of the product and/or service. The percentage may be set by business 220 or by the operator of the social network 230. The reward payment 222 is the total reward amount that is dispersed to the social network from business 220. Such a reward may serve, as not only an incentive for further purchases and a loyal customer base, but as a means to market to new customers that have not yet purchased a product and/or service from business 220.

The computer system that administrates the social network 220 receives the reward payment 222. The reward payment may be sent by or on behalf of the business 220. In some embodiments, the business 220 itself may send the reward payment. In other embodiments, an agent of the business 220 sends the reward payment on behalf of the business. Any suitable agent or third party may send the reward payment. For example, the reward payment may be sent from a financial institution associated with a credit card used by user 210 to make the purchase. In some embodiments, the payment for the product and/or service may be made to the social network itself and the reward payment may be withheld from the payment, with the remaining portion sent to the business 220 as the business's share of the payment.

The at least one computer system that administrates the social network, in the embodiment illustrated, handles the allocation and distribution of the reward payment. Any suitable technique may be used to determine which users of the social network receive a portion of the payment and what percentage of the total payment each user will receive. For example in some embodiments, the user 210 that made the purchase may receive a first percentage of the reward payment 222. One or more “friends” 240 of the user 210 may receive a different percentage of the reward payment 222. Friends 240 may be the users of the social network that are directly connected to user 210. These friends 240 are one degree of separation from the user 210 that performs the incented action. However, distribution of portions of the reward payment 222 is not limited to users that are directly connected to the user 210 via the social network. “Friends of friends” may also be allocated a portion of the reward payment. Friends of friends are the group of social network users that are directly connected to the users that are directly connected to user 210, but are not directly connected to user 210. These friends of friends are two degrees of separation from the user 210 that performs the incented action. Embodiments are not limited to any particular reward allocation computations. For example, some embodiments may utilize a reward allocation computation that distributes rewards to users of the social network that are any degree of separation from the user 210 that performs the incented action.

FIG. 2 illustrates a passive referral 214, whereby business 220 is referred to friends 240. This passive referral 214 is illustrated as a dashed line because no affirmative action is necessary for this referral to occur. The passive referral 214 is an automatic result of the connections that exist between users of the social network 230. For example, when a user 210 makes a purchase from business 220, the product and/or service purchased and the name of the business from which it was purchased may be posted on a social network webpage associated with user 210. By being connected via the social network, friends 240 see the information about the purchase and are thereby referred to the business without the user 210 needing to actively refer his friends 240. Though, other ways of making a referral may alternatively or additionally be used. For example, when a user is allocated a portion of a reward, the user may be sent an electronic message, or communication in some other form, by the business-to-network system, with similar information about the reward and business offering it.

The administrator of the business to network reward system, which in the illustrated embodiment is the operator of social network 230, in response to receiving the reward payment 222, may retain a portion of the reward payment for itself. For example, a small percentage or a fixed amount may be kept by the company that operates the at least one computer that administrates the social network 230. The social network 230 also distributes a portion of the rewards payment 222 to a set of users that is determined by the reward allocation computation. For example, a first percentage of the reward payment 222 is sent to an account associated with user via a reward distribution 232. A second percentage of the reward payment 222 is sent to at least one friend 240 via reward distribution 234. In some embodiments, the social network 230 may keep track of the total amount of rewards that have been distributed to each user of the social network. This total number may be displayed on a webpage of the social network associated with the respective user.

In some embodiments, a rewards account may also serve as a reloadable “ewallet,” tracking a credit that can be redeemed to make purchases or pay for other transactions for which electronic payment forms are accepted. For example, such an ewallet may be used to make payments to participating businesses. When the account is associated with a prepaid credit card, it can be used to make payments to any business where such a credit card is accepted.

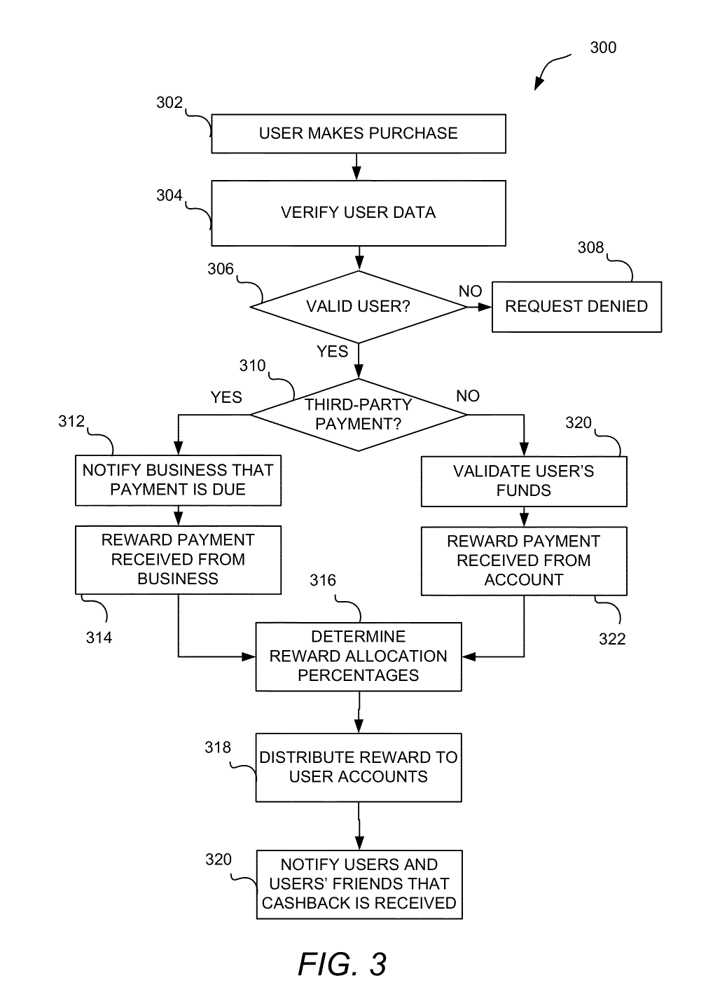

FIG. 3 illustrates a flowchart of a purchasing process 300 according to some embodiments of the present invention. A user makes a purchase from a business at act 302. The purchase may be made in any suitable way. In some embodiments, the purchase may be made through an online store for the business administrated by the social network itself. In other embodiments, the purchase may be made through an online store separate from the social network. For example, the user may select a product from the business from within the social network website that connects the user to the business's own website. In alternative embodiments, the purchase may be made at a physical store, not an online store.

Regardless of how the purchase is made, if that purchase constitutes an incented action, the purchase may be associated with a user of the business to network reward system. For example, at act 304, user data associated with the user making the purchase is verified. Users may identify themselves in any suitable way, such as by email, username, ID or a proprietary code.

Verification may be done in any suitable way and may depend on the how the user makes the purchase. For example, if the user makes the purchase through the online store within the social network itself, the identity of the user making the purchase is already available to the social network. The social network may ask the user to enter a password prior to finalizing the purchase to ensure the purchase is being made by the actual user of the social network account. In other embodiments, where a user makes a purchase from either an online store separate from the social network or from a physical store, the user may pay for the purchase using a credit card that is associated with the social network. By using this credit card, the purchases may be automatically linked to the social network account of the user. In other embodiments, the social network may provide the user with a loyalty card that is similar to loyalty cards currently offered by businesses and known in the art. However, instead of being associated with a single business, the loyalty card, according to some embodiments, identifies the user of the social network and links purchases made by the user to his social network account. Each affiliated business may have a scanner for scanning the loyalty card when a purchase is made or a place on the website to enter the loyalty card information so that the purchase is linked to the social network account. The business may then send the purchase information and the user identify information to the social network.

Verifying user data in act 304 alternatively or additionally may include acts other than verifying the identity of the user. Verifying the available funds to make the purchase may be part of verifying the user data. User payment data may have been previously entered, for example, when the user first joined the social network. In some embodiments, when the user joins the social network by, for example, accepting an invitation to join the social network from a friend, the user submits credit card account information and/or bank account information which is associated with the user. When a purchase is made, the business and/or the social network may verify that there are sufficient funds to complete the purchase.

If it is determined at act 306, based on the above verification of user data, that the user is not a valid user, the request to make the purchase may be denied. In some embodiments, the entire purchase may be denied. In other embodiments, the purchase may be allowed to continue. However, in this scenario the purchase is not linked to the user's social network account and, thus, no reward will be sent to the user's social network.

If, at act 306, it is determined that the user is a valid user, the process 300 continues to act 310 where it is determined if the user is using a third-party payment method. A third-party payment method may be any payment method not associated with the social network, such as a standard credit card, debit card or cash. Payment methods that are associated with the social network may include credit cards that are affiliated with the social network such that reward payments are directly paid from the credit card to the social network. Some embodiments may use other payment methods that are associated with the social network such as an electronic-wallet account that is affiliated with the social network or a pre-paid credit card or gift certificate affiliated with the social network.

If it is determined, at act 310, that a third party payment method is not being used, the process 300 continues to act 320 where the funds in the user's account are validated. The reward payment is then sent from the user's account and received by the social network at act 322. By using a payment method affiliated with the social network, reward payments may be received directly from the financial institution associated with the account, which may avoid the need for the business to send reward payments to the social network.

If it is determined, at act 310, that a third party payment method is used, the process 300 continues to act 312 where the business is notified that a reward payment is due. This notification may be done in any suitable way. In some embodiments, an affiliated business may have an account with the social network where the user may view payments that are due to the social network. In some embodiments, the business-to-network reward system may bill the business on a monthly basis, or any other suitable time frame. In other embodiments, payment may be effectuated by automatic deduction of payments from an account at a financial institution that the business previously linked to the social network for the purpose of paying reward payments. Alternatively or additionally, the business may submit the payment in connection with reporting that a reward was earned. Regardless of the specific trigger mechanism for transfer of payment from the business to the social network, the reward payment is received from the business by the social network at act 314.

Process 300 continues from either act 314 or act 322 to act 316, where the business to network reward system determines allocation of the reward. In the illustrated embodiment, this allocation is performed in a computer system of the social network that determines which users get a portion of the reward and what percentage of the reward is allocated to each user. Any suitable allocation computation may be used. For example, a portion of the reward may be distributed to each friend of the user that made the purchase, where a friend is a user of the social network that is directly connected to the user. In addition, in some embodiments, a portion of the reward may be distributed to users of the social network that are two degrees of separation from the user that made the purchase, i.e., friends of friends.

The amount that is distributed to each user of the social network who is determined to receive at least a portion of the reward may depend on a variety of factors. In some embodiments, the amount may depend on the degree of separation between the user earning the reward and the user to whom a portion of the reward is allocated. In some embodiments, the percentage of the reward allocated to a particular user may depend on the total number of friends that the purchaser has. Some embodiments may determine the percent allocated to a user based on the amount of time the user has been a member of the social network, which incentivizes people to join the social network early to increase their potential earnings from rewards. Other embodiments may determine the percentage of the reward allocated to a user based on the amount of time that the user has been connected to the purchaser as compared to other friends of the purchaser. The parameters of the allocation computation may be selected by the company that administrates the social network, the business that sold the product and/or service to the purchaser, and/or by the purchaser.

Though, any suitable qualifiers may be used to select or limit users in a social network to receive a share of a reward. For example, only others in the user's network who have agreed to participate in the reward sharing system may receive a share of the reward. Alternatively or additionally, only others in the network who have taken an incented action within some defined time period may be selected to receive a portion of the reward. Alternatively or additionally, characteristics of the others in the network may be used as a criteria such that only members of a social network having characteristics related to the incented action may share in the reward.

In some embodiments, before the reward is allocated to users of the social network, the company that administers the business-to-network reward system, which in this embodiment is the same entity that administers the social network, may take a portion of the reward. This portion retained by the administrator of the social network may be a percentage or a fixed amount per transaction. In some embodiments, the amount remaining after that portion is retained may be allocated in accordance with a computation, which may be performed on a computing device operated by the business-to-network reward system or any other suitable computer.

The following is an exemplary allocation computation. Embodiments of the invention are not limited to this particular allocation computation and one of skill in the art would understand that variations of the approach for allocating rewards are possible. In this example, the incented action is purchasing a product and the reward is in the form of cash back. Beginning with the total reward amount (TOTAL) that remains after the social network retains its portion, the exemplary allocation computation splits the total reward amount into three levels of distribution: A purchaser level (Level 0), a friend level (Level 1) and a friends-of-friends level (Level 2). The purchaser receives a first percentage (f0) of the reward, the purchaser's friends receive, as a group, a second percentage (f1) of the reward and the friends-of-friends receive, as a group, a third percentage (f2) of the reward. The three percentages, f0, f1 and f2 sum to one (f0+f1+f2=1). The amount distributed to the friends and the amount distributed to the friends-of-friends is further subdivided as described below.

An amount Cash0 represents the total reward that is kept by the buyer; an amount Cash1 represents the total reward that is allocated to the friends; and an amount Cash2 represents the total reward that is allocated to the friends-of-friends. These amounts are calculated as following:

Cash0=f0*TOTAL;

Cash1=f1*TOTAL;

Cash2=f2*TOTAL.

Because f0+f1+f2=1, Cash0+Cash 1+Cash2=TOTAL. Any suitable values of f0, f1 and f2 may be used. In some embodiments, f0<f1<f2, reflecting the fact that there is only one member of the purchaser group and the number users in the friends group is likely to be much smaller than the number of users in the friends-of-friends group. Though a higher percentage of the total reward may be allocated to the group as a whole, each individual from that group will likely receive a much smaller percentage of the total reward, as will be described below. In other embodiments, f1 is equal to f2 and they are both greater than f0. Some embodiments may set all three percentages equal to one another, i.e. f0=f1=f2=⅓.

Because there is only one purchaser, it is clear that the amount of cashback that the purchaser receives is equal to Cash0. But the other two amounts, Cash1 and Cash2, must be further divided and allocated to the members of each group.

The percentage of Cash1 that is allocated to each user of the friends group may be determined in any suitable way. For example, it may depend on two criteria: the number of friends that receive a reward (MaxFriends) and a percentage related to the amount of time each friend has been a member of the social network (pos %). Weighting factors (Wa and Wb) may also be used to determine the importance of each of these criteria in allocating the reward. By way of example, an individual user's cashback reward may be calculated as:

Individual Cashback=Wa*(pos %)*Cash1+Wb(1/MaxFriends)*Cash1.

The value of pos %, the percentage based on a particular user's “position” in the social network may be looked up in a table or by applying a mathematical formula. By way of example, the percentage associated with the user that has been a member of the social network for the longest period of time (pos %1) may be 30%; the percentage associated with next oldest member (pos %2) may be 15%; these allocations may continue in the manner as determined by the equation:

pos % N=30%/N,

where N is the position of the user in terms of seniority.

The weighting values Wa and Wb may be selected in any suitable way, but are normalized such that Wa+Wb=1. For example, in some embodiments, Wa=Wb and the two criteria are equally weighted. In other embodiments, the seniority of each user may be de-emphasized by making Wa<Wb.

MaxFriends may, in some embodiments, be equal to the total number of friends that the purchaser has. In other embodiments, a cap may be placed on the total number of friends that may receive a portion of a reward. If the purchaser has more friends than are allowed to receive cashback, any suitable method may be used to determine which friends get a reward. Some embodiments, may select the friends that have been members of the social network for the largest amount of time. Other embodiments may select the friends that have been friends with the purchaser for the longest period of time. In some embodiments, the friends may be selected at random or in accordance with any other suitable criteria to receive cashback.

The percentage of Cash2 that is allocated to each user of the friends-of-friends group may be determined in any suitable way. In some embodiments, the allocation may be determined in a similar way as described above for the friends group. For example, it may depend on the same criteria such as: the number of friends-of-friends that receive a reward (MaxFriendsOfFriends) and a percentage related to the amount of time each friend-of-friend has been a member of the social network (pos %). Weighting factors (Wc and Wd) may also be used to determine the importance of each of these criteria in allocating the reward. In some embodiments, Wc=Wa and Wd=Wb such that the same weighting is used for friends-of-friends as is used for friends. By way of example, an individual user's cashback reward may be calculated as:

Individual Cashback=Wc*(pos %)*Cash2+Wd(1/MaxFriendsofFriends)*Cash2.

In some embodiments, the same pos % table and/or equation may be used to determine the percentage based on seniority position amongst the group of friends-of-friends.

To illustrate the above allocation computation, an example purchase and cashback distribution is described. For this example, the following numerical values may be given to each of the aforementioned variables:

f0=0.2

f1=0.4

f2=0.4

Wa=Wc=0.3

Wb=Wd=0.7

MaxFriends=500

MaxFriendsOfFriends=2500

Pos %N=30%/N.

In this example, a user of the social network (the purchaser) makes a qualifying purchase of a $1000 item and the business selling the item offers 10% cashback on the item. Accordingly, the total amount of cash to be distributed to the social network is $100 (TOTAL=$100). From the above equations and values, it is determined that:

Cash0=0.2*$100=$20;

Cash1=0.4*$100=$40;

Cash2=0.4*$100=$40.

In other words, the purchaser receives $20 cashback, the friends of the purchaser will receive $40 cashback total, and the friends-of-friends will receive $40 cashback total as a reward for the purchaser buying the product.

The friend in the first position in the seniority ranking receives:

(0.3*30%*$40)+(0.7*(1/500)*$40)=$3.65.

The friend in the second position in the seniority ranking receives:

(0.3*15%*$40)+(0.7*(1/500)*$40)=$1.85.

These allocation calculations may be performed for each of the purchaser's 500 friends.

The friend-of-friend in the first position in the seniority ranking will receive:

(0.3*30%*$40)+(0.7*(1/2500)*$40)=$3.61.

The friend-of-friend in the second position in the seniority ranking will receive:

(0.3*15%*$40)+(0.7*(1/2500)*$40)=$1.81.

These allocation calculations may be performed for each of the purchaser's 2500 friends-of-friends.

After the reward allocations are determined at act 316, the process 300 continues to act 318 where the received reward is distributed to a plurality of users of the social network in accordance with the determined allocation percentages. In some embodiments, the distribution of rewards to the user of the social network may be done by depositing the determined reward amount into a bank account provided by each user at an earlier time. In other embodiments, a user may accumulate rewards on the social network without receiving the cashback immediately. Upon accumulating a certain amount of cashback, the user may receive a prepaid credit card with the accumulated amount from the company that administrates the social network. In some embodiments, instead of receiving a pre-paid credit card, the user may use the accumulated rewards to make a purchase in an online store that is part of the social network. Though, any suitable approach for making the rewards available to those who have accumulated them may be employed, including providing a mechanism for the users to redeem their rewards for vouchers, products, services, currency or to otherwise obtain something of value in proportion to the amount of the reward accumulated.

At act 320, the users who received a portion of the reward in act 318 are notified of the received reward. In some embodiments, the users may be notified by a post published on a social network webpage associated with the respective user. Alternatively, or additionally, the user may be sent an email to an email account that was previously registered with the social network. In some embodiments, the notification may include information about the business and/or purchased product that resulted in the reward. For example, a link to the business's website or online store may be included in the notification. Some embodiments may include user information in the notification. For example, the name of the user that made the purchase and a link to the user's profile page may be included in the notification.

The social network of some embodiments of the invention may allow users to create a wish list of products and/or services that the user would like to own. For example, a user may create a birthday present wish list or a holiday wish list. This wish list allows other users to purchase products that are desired by the user with the wish list and earn rewards in a similar way as rewards are earned for other purchases.

Though, providing a wish list alternatively or additionally may serve other purposes. For example, allowing users to post a “wish list” allows users to identify their interests. Such identification of interests may be the basis of one or more functions. For example, the wish list may serve as a way for the social network system to identify users of the social network system with shared interests, and may suggest that those users might want to connect to each other in a social network. Alternatively, the information about user preferences revealed through a wish list may enable the social network system to supply information to the user that aligns with that user's interests.

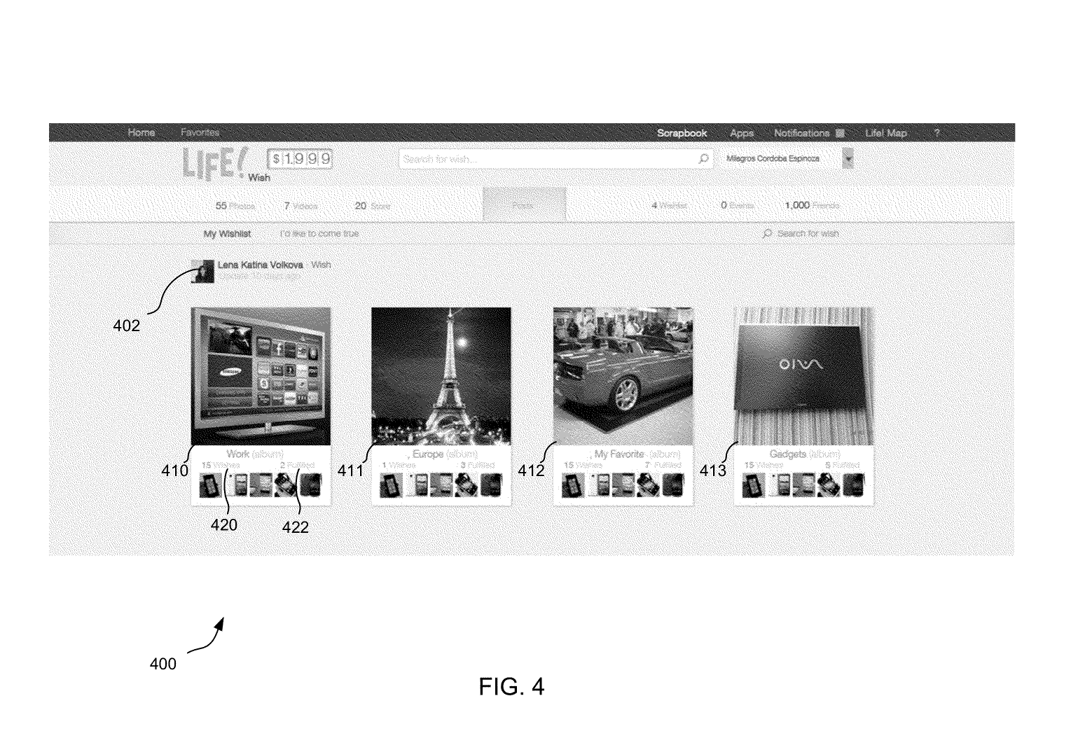

FIG. 4 illustrates a screenshot of a wish list webpage 400 within a social network according to some embodiments of the invention. The wish list is associated with a particular user 402 of the social network. A wish list may serve as a collection of products and/or services that a user desires to purchase herself or have purchased for her. A wish list may be created in any suitable way. For example, products listed on other user's social network webpages may contain a button that may be selected by user 402 for adding the product to her wish list.

In the embodiment illustrated, wish lists, by interaction with the business to network reward systems, incorporates a social expectation when they are created, a social reward when they are fulfilled and a reward benefit to of the users who create the wish lists. Such a feature may entice users to make use of a wish list. Accordingly, wish lists in the context of a business to network reward system may provide more value than in a conventional social network setting.

Items in a user's wish list may be purchased for the user by any user of the social network. Cashback incentives may differ for the purchasing of wishes as compared to a standard purchase by a user. In some embodiments, to incentivize gift giving, a higher percentage of the reward may be allocated to the purchaser of the gift. In other embodiments, in recognition of the fact that the wish maker is already receiving a gift from the purchaser, a portion of the reward may not be allocated to the receiver of the gift.

A wish list may be presented in any suitable form. For example, the wish list may be split into albums, or folders, based on categories 410-414 of products. For example, FIG. 4 illustrates a user's wish list with four categories 410-414 related to work, Europe, favorites items and gadgets, respectively. Each album may include an album cover image that represents the category of items within each album. The wish list may also include an indication of how many wishes are in each album and how many wishes have been fulfilled from each album. For example, as illustrated in FIG. 4, the Work album 410 is indicated by item 420 to contain 15 wishes and item 422 indicates that two wishes from the album have been fulfilled.

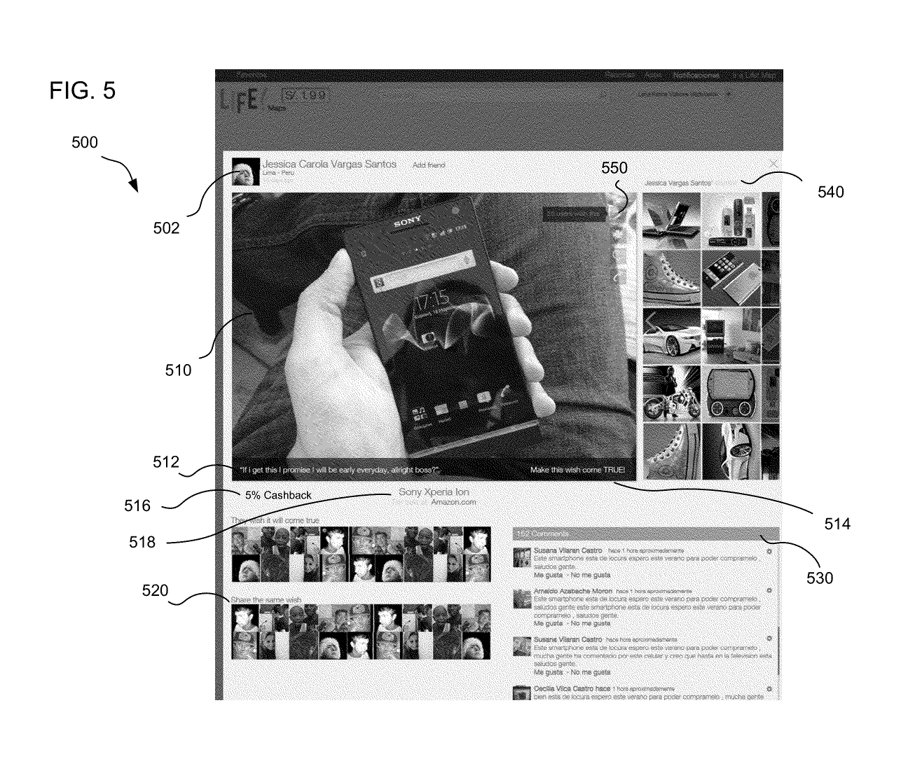

FIG. 5 illustrates a screenshot of a product display webpage 500 of a product contained within a wish list of a user 502. The product display webpage 500 includes an image 510 of the product. The user may provide a comment 512 about the wish and/or the product that is displayed on webpage 500. A button or link 514 is provided to allow a different user of the social network to fulfill the wish. In some embodiments, the link may lead to a webpage of the social network itself which allows the product to be purchased. In other embodiments, the link may lead to an external website of a business selling the product. The names 518 of the product and the business selling the product are also provided, as well as an indication of the reward incentive being offered by the business. Such an indication is provided, in this example, by element 516, and provides an example of how the business to network functionality increases the value of a conventional wish list. Some embodiments include a list and/or collection of links to other users 520 of the social network that are wishing for the same product. By providing this links to these other users, the user 502 may make new connections with users with similar interests and, upon visiting webpages of the social network associated with these users, may learn about additional products and/or services that user 502 may have an interest in purchasing or adding to her wish list. The webpage 500 includes a space for users to leave comments 530 regarding the wish. Links and photos of additional products and/or services 540 in the user's wish list may also be displayed on the webpage 500, thereby allowing users of the social network to quickly browse the other items that could be purchased for the user, purchased for themselves, or added to their own wish list.

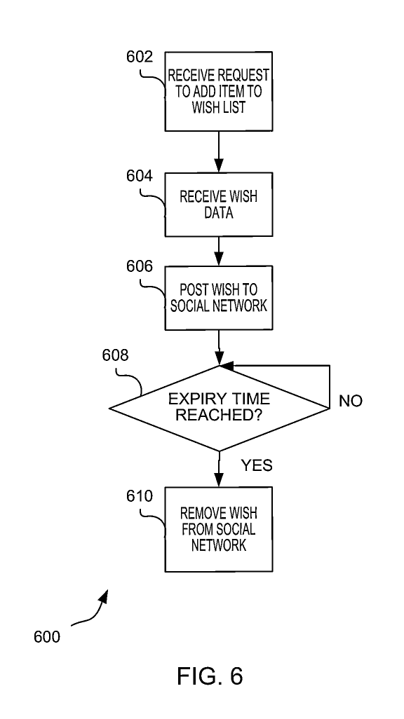

A wish list may be created in any suitable way. FIG. 6 illustrates a flowchart for creating a wish list in accordance with some embodiments of the invention. In this example, the wish list is implemented as part of a social network system. Accordingly, at act 602, the at least one computer system that administrates the social network receives a request from a user's computer to add an item to the user's wish list. In some embodiments, the request may be made by selecting a button or a link on a webpage of the social network associated with the item. For example, the user may be browsing her friends' wish lists and see an item that she would like to own. The webpage that displays the desired item in her friend's wish list may include a button 550 which any user of the social network may select to add the item to their own wish list. In other embodiments, the user may be browsing a webpage that is a store associated with the social network. Each product in the store may have a button or link that may be selected to request that the item be added to the user's wish list. In some embodiments, the user may be browsing products on a website outside of the social network that displays products. A button or link may be provided on these third-party websites that, when selected, sends the request to add the respective item to the wish list of a logged in user of the social network. Though, any suitable technique for specifying information about a product may be used to identify products to include on a wish list.

At act 604, the at least one computer system that administrates the social network receives wish data. In some embodiments, the wish data may include information entered by the user in response to a computer dialogue window that opens on the user's computer upon selecting the button or link to add an item to the user's wish list. Alternatively, or additionally, wish data may be provided by the business selling the item. The wish data may include a title for the item, a user comment 512 (see FIG. 5), a photograph 510 of the product being added, the name of the album 410 of the wish list to which the item will be added, privacy setting values for the wish, information about the percent cash back 516 being offered, an expiry date and time of the wish and/or any other suitable information about the wish.

At act 606, the at least one computer system that administrates the social network posts the wish to the profile page of the user on the social network. In some embodiments, privacy settings may be used to determine which users of the social network can see the post. For example, the user may set the privacy setting so that friends see the post. Alternatively, the user may select privacy settings that make the post viewable to friends of friends or users of a selected degree of separation from the user. In some embodiments, the post may be made public for all users of the social network system to see whether or not connected to the user is a social network.

At act 608, it is determined whether the expiry date and time of the wish is reached. If the user does not enter an expiry date and time, then there is none and process 600 never reaches act 610. The wish will continue to exist until it is either fulfilled or removed manually by the user. If it is determined that the expiry date and time has been reached, then the wish is removed from the user's profile page. In some embodiments, before removing the wish, the user may be asked to confirm the removal of the wish via, for example, a dialogue window. In some embodiments, an expiry date and time may be associated with an album of the wish list such that each wish in the album expires at the same time. For example, a user may have a wish list album entitled “Birthday.” The user may set the wishes in this album to expire, and therefore be removed from the social network at act 610, shortly after her birthday.

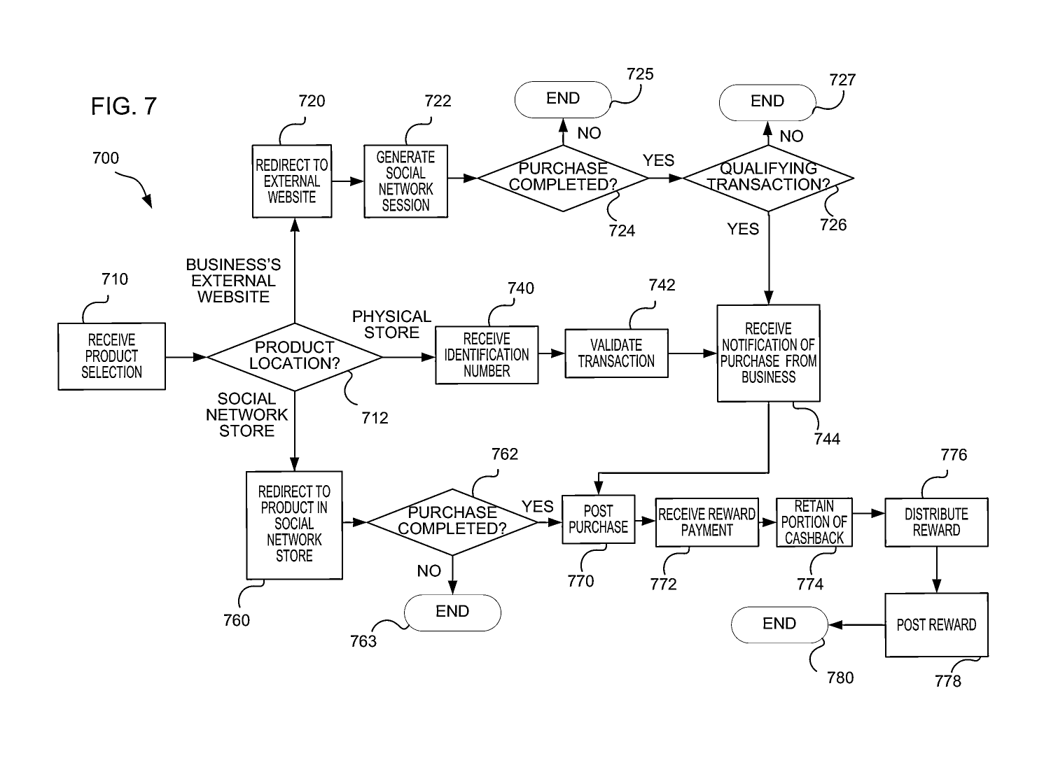

FIG. 7 illustrates an exemplary flow chart of the business-to-network process according to some embodiments of the invention. In this example, the business-to-network system is implemented as part of a social network system. Accordingly, in this embodiment, at act 710, a user of the social network makes a product and/or service selection from a webpage within the social network. The selection may be made from any suitable client computer and is received by the at least one computer system administrating the social network. The product selection indicates that the user would like to purchase the product. In some embodiments, the indication may specify that the product being purchased is a wish of a different user. The process 700 is similar whether the purchaser is the recipient of the product or whether a different user is the recipient of the product.

At act 712, the location of the product selected by the user is determined. In the embodiment illustrated in FIG. 7, the location options for the product are: an online store that is part of the social network, a business's external online store website, or a physical store of the business selling the product. Embodiments are not limited to these three product locations. One of skill in the art would appreciate that other options are possible and could be used in embodiments of the invention. For example, a third party website operated by an entity other than the social network company and the business selling the item may act as the location of the product.

If it is determined at act 712 that the product is located in an online store that is a part of the social network, the user's computer is redirected to the product in the social network's store at act 760. At act 762, it is determined whether the purchase is completed by the user.

If the user never completes the purchase, then the process 700 ends at act 763. If the purchase is completed, process 700 continues to act 770, where information about the purchase is posted to the user's profile page.

If, at act 712, it is determined that the product is located at a website external to the social network, process 700 continues to act 720 where the user is redirected to the external website. The external website may be any suitable such as an online store. In some embodiments, the external website may be an online store operated by the business selling the product.

At act 722, a social network session is generated between the social network and the external website. While the user interacts directly with the external website, the social network session may ensure that information about the session is communicated to the social network. For example, information that the user enters into the external website may be shared with the social network. In some embodiments, the social network may send information to the external website via the social network session. For example, the social network may verify the identity of the user for the external website so that the external website may process the transaction with the user as a transaction that is part of the business to network reward system.

At act 724, it is determined whether the purchase is completed by the user. If the purchase is not complete, then process 700 ends at act 725. A purchase may not be complete for a variety of reasons. In some embodiments, the user may leave the external website before the purchase is made. In other embodiments, the user may not enter a valid form of payment. If the purchase is completed, it is determined whether the purchase is a qualifying purchase at act 726. If the transaction does not qualify, then process 700 terminates at act 727. There may be a variety of reasons for a purchase to be disqualified from the business to network reward system. For example, a business may offer rewards only for certain items. If the user purchases only items where rewards are not offered, then the purchase may not be considered a qualifying transaction. In other embodiments, if a user modifies the order after the order is placed, the order may not qualify as a transaction eligible for a reward. In some embodiments, if a purchaser uses a discount code or coupon in the external website, the business-to-network reward may be disqualified. If it is determined that the purchase is a qualifying transaction at act 726, then process 700 continues to act 744.

If, at act 712, it is determined that the selected product is located in a physical store, process 700 continues to act 740 where the business to network reward system receives an identification number from the physical store. This identification number may be provided by the user when making a purchase at the physical store. The user may have received the identification number from the business to network reward system. Though, any suitable identification number may be used. In some embodiments, the identification number may identify the purchaser as a member of the social network. In some embodiments, the identification number may be associated with a credit card that is associated with the social network such that the identification number is provided to the physical store simply by paying for the product using said credit card. In other embodiments the identification number may be provided to the physical store using a loyalty card which the store may scan when the purchase is made. In other embodiments, the identification number may represent a number that identifies a wish made by a user of the social network other than the purchaser. The user may receive this wish identification number and bring it to the physical store so that, when the purchase is made, the physical store may send the wish identification to the business to network reward system so that the wisher's wish list may be updated to reflect the wish being fulfilled.

At act 742, the transaction is validated by the business to network reward system. Validation may be performed in any suitable way. In some embodiments, the received identification number may be validated to ensure the purchaser is a valid user of the social network. In other embodiments, the received identification number may be validated to ensure the associated wish is still a valid wish. Some embodiments may validate whether the purchase is eligible for a reward via the business to network reward system.

At act 744, the business to network reward system receives a notification of a completed purchase by the user from the business. This act may be reached, for example, after it is determined that a qualifying transaction occurred on an external website at act 726 or after a transaction at a physical store is validated by the business to network reward system at act 742. However, embodiments of the invention are not so limited and act 744 may be performed at any suitable time and after any suitable transaction.

At act 770, the user's purchase is posted on at least one profile page of the social network. This act may be reached, for example, after a purchase is completed via the social network store at act 762 or after receiving a notification of a completed purchase by the user from the business at act 744. However, embodiments of the invention are not so limited and act 770 may be performed at any suitable time and after any suitable transaction. In some embodiments, information pertaining to the purchase may be published to a profile page of the purchaser. In other embodiments, where the purchase is a wish fulfillment, purchase information may be published to both the purchaser's profile page and the recipient's profile page. However, it should be appreciated that processing at act 770 is an example of a technique used to distribute reward information associated with a transaction. Such information may be distributed in any suitable way, including by electronic communications directly to other users of a social network.

At act 772, the business to network reward system receives the reward payment associated with the purchase. In some embodiments, this payment may be received from the business that sold the item. In other embodiments, the payment may be received from an institution administering a credit or debit card account used to purchase the item. In other embodiments, where, for example, the purchase was paid for using accumulated points or unredeemed cashback accrued within the business to network reward system by the user, the reward payment may be a transfer of points or cashback rewards between the user and the business to network reward system.

At act 774, the company that administrates the business to network reward system (which in this example may be the same entity that administers to social network) may retain a portion of the reward. This retained portion is compensation for providing the business to network reward system to the users and the business that benefit from the reward system. The retained portion of the reward may be calculated in any suitable way. In some embodiments, the retained portion may be a fixed fee per transaction. In other embodiments, the retained portion may be a percentage of the total reward.

At act 776, the reward is distributed to one or more users of the social network. The reward may be allocated to the users of the social network in any suitable way. As discussed above, an allocation computation may depend on a variety of factors and may allocate portions of the reward to users of the social network that are any degree of separation from the user that makes the purchase. In some embodiments, the reward is distributed to a user by transferring money into a bank account associated with the respective user. In other embodiment, the user may accumulate points in an account managed by the social network system that may be redeemed at a later time. The points may be redeemed, for example, to purchase an item from a business. Alternatively, the points may be redeemed for cash.

At act 778, the reward is posted to the social network. For example, a profile page associated with each user of the social network that receives a portion of the reward may be updated to display information about the reward. In some embodiments, the amount of the portion of the reward received by a particular user may be posted. The product purchased and the name of the purchaser may also be published in some embodiments. In embodiments where the purchase fulfilled a wish, the name of the purchaser and the name of the recipient may be posted. However, it should be appreciated that processing at act 780 is an example of a technique used to distribute reward information associated with a reward. Such information may be distributed in any suitable way, including by electronic communications directly to other users of a social network.

Process 700 ends at act 780.

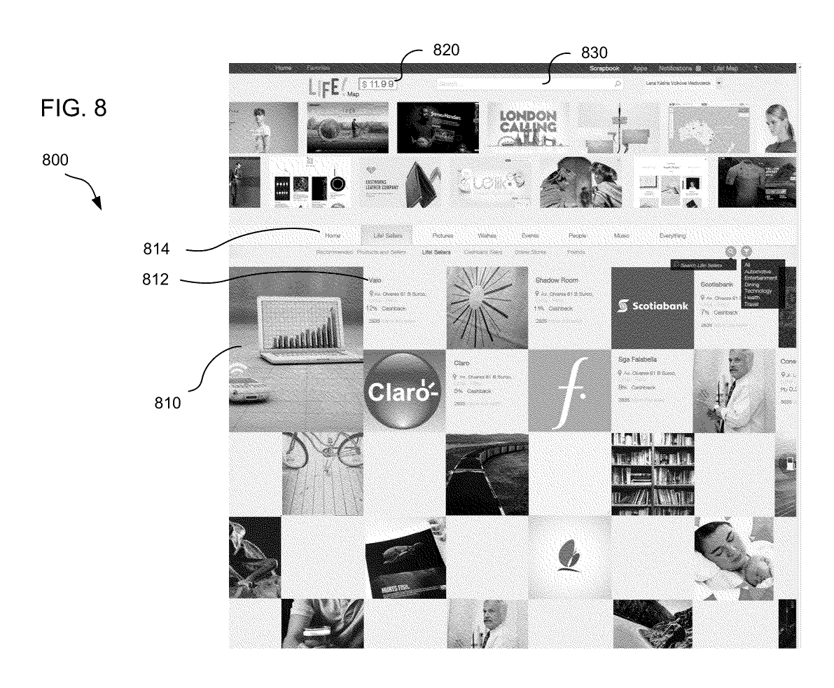

FIG. 8 is a screenshot of a sellers' marketplace 800 in accordance with some embodiments. The sellers' marketplace 800 may include images 810 of products that may be purchased by users of the social network. These images may represent wishes of other users, such as friends of the user viewing the marketplace, products previously purchased by other users, products “liked” by other users, and/or products offered for sale by businesses that the user “likes.” Each product image may also be associated with information about the product 812. The information about the product may include the name of the product, the location where the product may be purchased, the price of the product, the type of reward. The sellers' marketplace 800 may also offer a variety of filters 814 to limit the type of information displayed on the sellers' marketplace 800. For example, the products may be filtered to show only wishes, products associated with particular businesses or a particular type of business, or products associated with a particular friend or group of friends. The sellers' marketplace 800 may display the total amount of rewards 820 received by the user the rewards may be accumulated over any suitable time frame, such as since joining the social network. Alternatively, the displayed rewards may represent accumulated rewards that have not yet been redeemed. The amount of rewards may be displayed as points or a cash amount. This total amount of rewards may be displayed on any webpage of the social network viewed by the user and is not limited to being displayed only in the sellers' marketplace. The sellers' marketplace 800 may include a search area 830, which may be used by the user to search for people, businesses, products, services, or any other suitable information contained in the business to network reward system.

In some embodiments, a user may share product and/or business information with one or more users without making a purchase or adding a product to a wish list. For example, if a first user learns of a product that is believed to be of interest to a second user, the first user may share this product information with the second user. This sharing may be done in any suitable way. In some embodiments, the first user may user a private messaging mechanism of the social network to send the product information. In other embodiments, the first user may post the product information on a second user's profile page. The post may include user information about the first user. In some embodiments, the post may include a message from the first user to the second user.

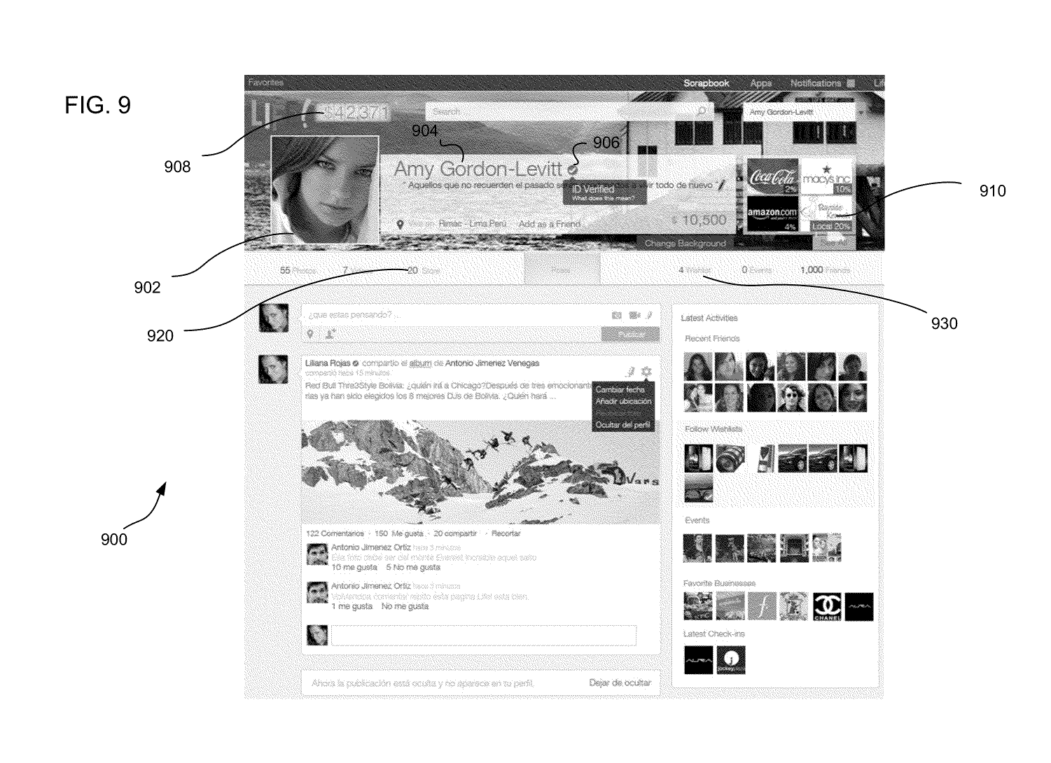

FIG. 9 is a screenshot of a user's profile page 900 in accordance with some embodiments. Each user and each business may have a profile page. The profile page 900 may include an image 902, selected by the user, to identify herself to other uses and the name 904 of the user. In some embodiments, the name of the user may be an ID verified name. Users with ID verified names may be indicated in some way to other users. For example, in the embodiment of FIG. 9, the ID verified name of the user is visually indicated with a graphic of a checkmark 906.

The profile page 900 may also include an indicator 908 of the total rewards received by the user from the business to network reward system over the lifetime of the user's account. The indicator may increase each time a friend, or friend of a friend, makes a qualifying purchase. Displaying each users total rewards may add a gaming aspect to the business to network reward system. Users may desire to earn more rewards than their friends. By creating this gaming environment, users are further incentivized to make purchases through participating businesses, invite more friends to become users of the business to network reward system, and extend their network of friends to include more users of the business to network reward system.

The user's profile page 900 may also include an indication 920 of the user's favorite businesses or “liked” businesses. Any suitable indication may be used. For example, the indication may take the form of an image and/or text. In some embodiments, the image used to indicated that a business is one of the user's favorite businesses is the same image selected by the business to identify itself on the business's own profile page. In some embodiments, the indication may include an notification of the type of rewards being offered by the business when purchases are made. For example, a percent cashback may be indicated using text over the image identifying the business.

In some embodiments, the user's profile page may include a button or link 920 that re-directs other users to the user's personal store. The button or link may include an indication of how many items the user has for sale. In some embodiments, the button or link may include an indication of the type of rewards being offered by the user when purchases are made. For example, a percent cashback may be indicated using text on or near the button or link to the user's store.

In some embodiments, the user's profile page may include a button or link 930 that re-directs other users to the user's wish list. The button or link may include an indication of how many items are in the user's wish list. In some embodiments, the button or link may include an indication of the type of rewards being offered by the businesses selling the items on the wish list. For example, a percent cashback may be indicated using text on or near the button or link to the user's wish list.

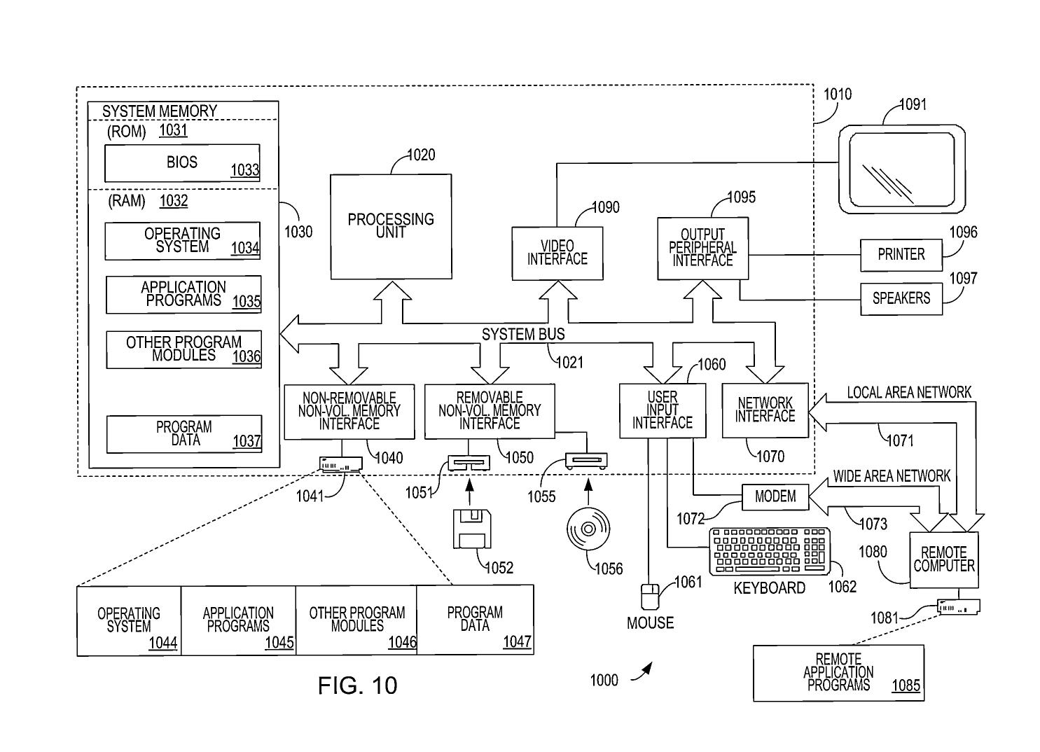

FIG. 10 illustrates an example of a suitable computing system environment 1000 on which the invention may be implemented. The computing system environment 1000 is only one example of a suitable computing environment and is not intended to suggest any limitation as to the scope of use or functionality of the invention. Neither should the computing environment 1000 be interpreted as having any dependency or requirement relating to any one or combination of components illustrated in the exemplary operating environment 1000.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 10, an exemplary system for implementing the invention includes a general purpose computing device in the form of a computer 1010. In some embodiments, the computer 1010 may be used as the client computers 191-194, the computer system 170, and/or the business's computer 164 of FIG. 1B. Components of computer 1010 may include, but are not limited to, a processing unit 1020, a system memory 1030, and a system bus 1021 that couples various system components including the system memory to the processing unit 1020. The system bus 1021 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 1010 typically includes a variety of computer readable media. Computer readable media can be any available media that can be accessed by computer 1010 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 1010. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of the any of the above should also be included within the scope of computer readable media.

The system memory 1030 includes computer storage media in the form of volatile and/or nonvolatile memory such as read only memory (ROM) 1031 and random access memory (RAM) 1032. A basic input/output system 1033 (BIOS), containing the basic routines that help to transfer information between elements within computer 1010, such as during start-up, is typically stored in ROM 1031. RAM 1032 typically contains data and/or program modules that are immediately accessible to and/or presently being operated on by processing unit 1020. By way of example, and not limitation, FIG. 10 illustrates operating system 1034, application programs 1035, other program modules 1036, and program data 1037.

The computer 1010 may also include other removable/non-removable, volatile/nonvolatile computer storage media. By way of example only, FIG. 10 illustrates a hard disk drive 1041 that reads from or writes to non-removable, nonvolatile magnetic media, a magnetic disk drive 1051 that reads from or writes to a removable, nonvolatile magnetic disk 1052, and an optical disk drive 1055 that reads from or writes to a removable, nonvolatile optical disk 1056 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1041 is typically connected to the system bus 1021 through an non-removable memory interface such as interface 1040, and magnetic disk drive 1051 and optical disk drive 1055 are typically connected to the system bus 1021 by a removable memory interface, such as interface 1050.

The drives and their associated computer storage media discussed above and illustrated in FIG. 10, provide storage of computer readable instructions, data structures, program modules and other data for the computer 1010. In FIG. 10, for example, hard disk drive 1041 is illustrated as storing operating system 1044, application programs 1045, other program modules 1046, and program data 1047. Note that these components can either be the same as or different from operating system 1034, application programs 1035, other program modules 1036, and program data 937. Operating system 1044, application programs 1045, other program modules 1046, and program data 1047 are given different numbers here to illustrate that, at a minimum, they are different copies. A user may enter commands and information into the computer 1010 through input devices such as a keyboard 1062 and pointing device 1061, commonly referred to as a mouse, trackball or touch pad. Other input devices (not shown) may include a microphone, joystick, game pad, satellite dish, scanner, or the like. These and other input devices are often connected to the processing unit 1020 through a user input interface 1060 that is coupled to the system bus, but may be connected by other interface and bus structures, such as a parallel port, game port or a universal serial bus (USB). A monitor 1091 or other type of display device is also connected to the system bus 1021 via an interface, such as a video interface 1090. In addition to the monitor, computers may also include other peripheral output devices such as speakers 1097 and printer 1096, which may be connected through a output peripheral interface 1095.

The computer 1010 may operate in a networked environment using logical connections to one or more remote computers, such as a remote computer 1080. The remote computer 1080 may be a personal computer, a server, a router, a network PC, a peer device or other common network node, and typically includes many or all of the elements described above relative to the computer 1010, although only a memory storage device 1081 has been illustrated in FIG. 10. The logical connections depicted in FIG. 10 include a local area network (LAN) 1071 and a wide area network (WAN) 1073, but may also include other networks. Such networking environments are commonplace in offices, enterprise-wide computer networks, intranets and the Internet.

When used in a LAN networking environment, the computer 1010 is connected to the LAN 1071 through a network interface or adapter 1070. When used in a WAN networking environment, the computer 1010 typically includes a modem 1072 or other means for establishing communications over the WAN 1073, such as the Internet. The modem 1072, which may be internal or external, may be connected to the system bus 1021 via the user input interface 1060, or other appropriate mechanism. In a networked environment, program modules depicted relative to the computer 10, or portions thereof, may be stored in the remote memory storage device. By way of example, and not limitation, FIG. 10 illustrates remote application programs 10 as residing on memory device 1081. It will be appreciated that the network connections shown are exemplary and other means of establishing a communications link between the computers may be used.

Having thus described several aspects of at least one embodiment of this invention, it is to be appreciated that various alterations, modifications, and improvements will readily occur to those skilled in the art.

For example, embodiments have been described in which a business-to-network system is implemented by the same entity that provides a social network system. However, there is no requirement that the same entity administer both systems. In other embodiments, functions of the business-to-network system described above as implemented by the social network system may be performed by a different entity.

Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

1. A method of operating at least one computing device to provide rewards to users of a social network, the social network being implemented by the users' interactions with a computing system, the method comprising:
receiving information about an incented action, by a first user of the social network;
distributing a reward for taking the incented action to the first user of the social network and at least one other user of the social network, wherein the at least one other user of the social network is selected to receive a portion of the reward based on a connection to the first user within the social network, and wherein the at least one other user is not selected based on any action within the social network performed by the at least one other user that prompted the first user to take the incented action.

2. The method of claim 1, wherein the reward is a cashback reward and distributing the reward comprises recording in a computer-readable medium associated with the computing device a credit to an account of the first user with a fraction of the amount of the cashback reward.

3. The method of claim 1, wherein:
the at least one incented action is a purchase made through a business;
the business is registered with the social network; and
the method further comprises:
receiving a reward payment from the business.

4. The method of claim 3, wherein the method further comprises:
distributing a first percentage of the reward payment to the first user of the social network;
distributing a second percentage of the reward payment to at least one other user of the social network; and
retaining a third percentage of the reward payment for an operator of the computing device through which the social network is implemented.

5. The method of claim 3, wherein:
the reward payment is a percentage of a price of the product or service; and
the business determines the percentage.

6. The method of claim 1, wherein the incented action is a purchase made through an online store that is part of the social network.

7. The method of claim 1, wherein distributing the reward comprises:
distributing a first percentage of a reward payment to the first user of the social network;
distributing a second percentage of the reward payment to a second user of the social network; and
distributing a third percentage of the reward payment to a third user of the social network.

8. The method claim 7, wherein:
the second user is connected to the first user via the social network;
the third user is connected to the second user via the social network, but not the first user; and
the method further comprises computing the second percentage and the third percentage based on a degree of separation from the first user such that the third percentage is less than the second percentage.

9. The method claim 7, wherein:
the second user connected to the first user via the social network, wherein the second user has been a member of the social network for a first amount of time;
the third user connected to the first user of the social network, wherein the third user has been a member of the social network for a second amount of time; and
the method further comprises computing the second percentage and the third percentage based on the length of time the second user and third user have been members of the social network such that the third percentage is less than the second percentage.

10. The method of claim 1, wherein the incented action comprises use of a credit card or mobile payment system issued by a business offering a reward for use of the credit card or mobile payment system.

11. The method of claim 1, wherein the incented action comprises purchase of a product identified by a business associated with a business to network reward system.

12. At least one computing device for use in administering a business to network reward system in connection with a social network, the at least one computing device comprising:
at least one network interface adapted to receive requests from a plurality of users of the social network and a plurality of businesses affiliated with the social network;
at least one memory device adapted to store user information, business information and transaction information, the transaction information being related to transactions between users and businesses;
at least one processor adapted to manage the user information, the business information and the transaction information, the processor performing acts of:
receiving, from the network interface, information about a transaction by a first user of the social network, the transaction involving a business affiliated with the social network;
updating first user information of a first user stored in the at least one memory device, by allocating a portion of a reward to the first user, the reward being based on the transaction; and
updating second user information stored in the at least one memory, the second user information relating to a plurality of second users of the social network, and the second user information being updated by allocating a portion of the reward to each of the plurality of second users, wherein each of the plurality of second users is connected to the first user via the social network, and is selected to receive a portion of the reward based on a direct connection to the first user within the social network and, and wherein the plurality of second users are not selected based on any action within the social network performed by any of the plurality of second users that prompted the first user to take the incented action.

13. The at least one computing device of claim 12, wherein:
the at least one computing device comprises at least one server implementing an interface between a reward system and a social network system.

14. The at least one computing device of claim 12, wherein:
the at least one processor is further adapted to compute a portion of the reward allocated to a plurality of third users based on a degree of connectedness within the social network.

15. At least one non-transitory computer-readable storage medium comprising computer-executable instructions that, when executed, perform a method of providing rewards to users of a social network, the method comprising:
receiving information about at least one transaction related to a business, the transaction being performed, by a first user of the social network;
allocating a reward for performing the transaction to the first user of the social network and a plurality of second users of the social network, wherein the plurality of second users are selected to receive a portion of the reward based on being connected to the first user in the social network, and wherein the plurality of second users are not selected based on any action within the social network performed by the at least one other user that prompted the first user to take the incented action.

16. The at least one non-transitory computer-readable storage medium of claim 15, wherein the method further comprises computing a first percentage of the reward to allocate to the first user and computing a second percentage of the reward to allocate to the plurality of second users.

17. The at least one non-transitory computer-readable storage medium of claim 16, wherein computing the first percentage of the reward to allocate to the first user and computing the second percentage of the reward to allocate to the plurality of second users comprises computing a respective percentage of the reward to allocate to each of the plurality of second users based on a degree of separation from the first user within the social network.

18. The at least one non-transitory computer-readable storage medium of claim 16, wherein computing the first percentage of the reward to allocate to the first user and computing the second percentage of the reward to allocate to the plurality of second users comprises computing a respective percentage of the reward to allocate to each of the plurality of second users based on a length of time each of the at least one other users has been a member of the social network.

19. The at least one non-transitory computer-readable storage medium of claim 16, wherein allocating the reward comprises updating user information stored in computer-readable storage medium associated with accounts of the first user and each of the plurality of second users.

20. The at least one non-transitory computer-readable storage medium of claim 16, wherein the method further comprises providing access by each user of the first user and the plurality of second users to accumulated rewards allocated to the respective user.

21. The method of claim 1, wherein the at least one other user is further selected based on the selected at least one other user being directly connected to the first user within the social network.

22. The at least one computing device of claim 12, wherein each of the plurality of second users is further selected independently of taking an action to cause the first user to take the incented action.

23. The method of claim 1, wherein distributing the reward comprises distributing the reward in real time.

24. The method of claim 1, wherein the distributed reward is a dynamic reward that changes over time based on input received from at least one business associated with the incented action.

25. The method of claim 1, wherein the incented action is a purchase made through an online store using an electronic-wallet account affiliated with the social network.

26. The method of claim 25, wherein an entity responsible for the computing system implementing the social network receives a portion of the reward.

27. The method of claim 25, wherein the purchase using the electronic-wallet is paid for, at least in part, using unredeemed rewards received with previous incented actions performed by the first user.

28. The method of claim 1, wherein the reward is a points reward and distributing the reward comprises recording in a computer-readable medium associated with the computing device a point credit to an account of the first user with a fraction of the amount of the point reward.
